(19) United States
(12) Patent Application Publication
(10) Pub. No.: US 2012/0225650 A1
(43) Pub. Date: Sep. 6, 2012

(54) METHOD AND APPARATUS FOR CONTROLLING RELAY STATION MODE OF MOBILE STATION IN A COMMUNICATION SYSTEM

(75) Inventors: Yeong-Moon SON, Yongin-si (KR); Rakesh TAORI, Suwon-si (KR); Young-Bin CHANG, Anyang-si (KR); Jae-Hyuk JANG, Suwon-si (KR); Kyung-Kyu KIM, Seoul (KR)

(73) Assignee: SAMSUNG ELECTRONICS CO. LTD., Suwon-si (KR)

(21) Appl. No.: 13/408,423

(22) Filed: Feb. 29, 2012

(30) Foreign Application Priority Data
Mar. 4, 2011 (KR) 10-2011-0019317

(51) Int. Cl. H04W 36/06; H04B 7/15

(52) U.S. Cl. 455/434

(57) ABSTRACT

A method and an apparatus for a Mobile Station (MS) to control a Relay Station (RS) mode of the MS in a communication system are provided. The method includes sensing a link loss with a serving Base Station (BS), searching for a neighbor BS for network reentry, transmitting to the neighbor BS an Identifier (ID) of the serving BS and an indication indicating network reentry from coverage loss caused by movement out of a service area of the serving BS are, and operating in the RS mode, upon receipt of an indication commanding switch to the RS mode from the neighbor BS, wherein the RS mode is a mode in which the MS operates as an RS.

### PRIORITY

This application claims priority under 35 U.S.C. §119(a) to a Korean Patent Application filed in the Korean Intellectual Property Office on Mar. 4, 2011 and assigned Serial No. 10-2011-0019317, the contents of which are incorporated herein by reference.

### BACKGROUND OF THE INVENTION

1. Field of the Invention

The present invention relates to a method and apparatus for controlling a communication system. More particularly, the present invention relates to a method and apparatus for controlling a Relay Station (RS) mode of a Mobile Station (MS) in a communication system.

2. Description of the Related Art

To extend service coverage and increase reliability, an MS has a function of operating as a Relay Station (RS) (hereinafter, referred to as an RS mode) in a communication system.

However, no conditions and situations in which an MS can operate in the RS mode have been specified so far.

Therefore, a conventional RS mode-enabled MS can operate as an RS at any intended time. This RS-mode operation of the MS may interfere with other RSs and too many RSs may exist within the service area of a Base Station (BS) that covers the MS. Accordingly, there exists a need for specifying restrictions on the RS-mode operation of an RS mode-enabled MS.

### SUMMARY OF THE INVENTION

Aspects of the present invention are to address at least the above-mentioned problems and/or disadvantages and to provide at least the advantages described below. Accordingly, an aspect of the present invention is to provide a method and apparatus for controlling a Relay Station (RS) mode of a Mobile Station (MS) in a communication system.

In accordance with an aspect of the present invention, a method for an MS to control an RS mode of the MS in a communication system is provided. The method includes sensing a link loss with a serving Base Station (BS), searching for a neighbor BS for network reentry, transmitting to the neighbor BS an Identifier (ID) of the serving BS and an indication indicating network reentry from coverage loss caused by movement out of a service area of the serving BS, and operating in the RS mode, upon receipt of an indication commanding switch to the RS mode from the neighbor BS, wherein the RS mode is a mode in which the MS operates as an RS.

In accordance with another aspect of the present invention, a method for a BS to control an RS mode of an MS in a communication system is provided. The method includes receiving from the MS an ID of a link-lost serving BS and an indication indicating network reentry from coverage loss caused by movement out of a service area of the serving BS, determining whether the serving BS cannot service any MS within the service area of the serving BS in an out-of-service state, and transmitting an indication commanding switch to the RS mode to the MS, if the BS is in the out-of-service state, wherein the RS mode is a mode in which the MS operates as an RS.

In accordance with another aspect of the present invention, an MS for controlling an RS mode in a communication system is provided. The system includes a controller for sensing a link loss with a serving BS, for searching for a neighbor BS for network reentry, and operating in the RS mode, upon receipt of an indication commanding switch to the RS mode from the neighbor BS, and a transmitter for transmitting to the neighbor BS an ID of the serving BS and an indication indicating network reentry from coverage loss caused by movement out of a service area of the serving BS, wherein the RS mode is a mode in which the MS operates as an RS.

In accordance with a further aspect of the present invention, a BS for controlling an RS mode of an MS in a communication system is provided. The BS includes a receiver for receiving from the MS an ID of a link-lost serving BS and an indication indicating network reentry from coverage loss caused by movement out of a service area of the serving BS, a controller for determining whether the serving BS cannot service any MS within the service area of the serving BS in an out-of-service state, and a transmitter for transmitting an indication commanding switch to the RS mode to the MS, if the BS is in the out-of-service state, wherein the RS mode is a mode in which the MS operates as an RS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an exemplary situation referred to for describing an exemplary embodiment of the present invention;

FIG. 2 is a diagram illustrating an overall procedure for determining whether a Mobile Station (MS) is to operate in a Relay Station (RS) mode by a Base Station (BS) according to an exemplary embodiment of the present invention;

FIG. 3 is a flowchart illustrating an operation of an MS according to an exemplary embodiment of the present invention;

FIG. 4 is a flowchart illustrating an operation of a BS according to an exemplary embodiment of the present invention;

FIG. 5 illustrates an exemplary situation referred to for describing another exemplary embodiment of the present invention;

FIG. 6 is a diagram illustrating an overall procedure for autonomously determining whether to operate in an RS mode by an MS according to another exemplary embodiment of the present invention;

FIG. 7 is a flowchart illustrating an operation of an MS according to another exemplary embodiment of the present invention;

FIG. 8 is a flowchart illustrating an operation of a BS according to another exemplary embodiment of the present invention;

FIG. 9 is a block diagram of a BS that operates according to an exemplary embodiment of the present invention; and

FIG. 10 is a block diagram of an MS that operates according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and apparatus for controlling a Relay Station (RS) mode of a Mobile Station (MS) in a communication system. In an exemplary embodiment of the present invention, an MS operates in the RS mode under control of a Base Station (BS). In another exemplary embodiment of the present invention, the MS autonomously controls its RS mode.

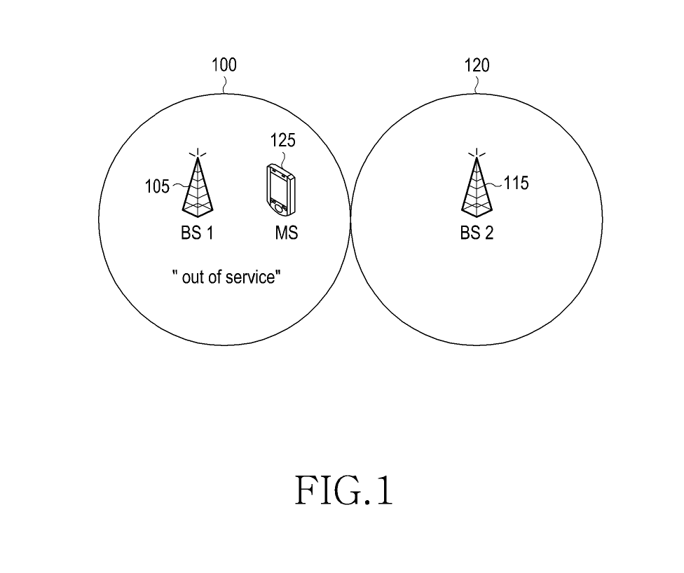

FIG. 1 illustrates an exemplary situation referred to for describing an exemplary embodiment of the present invention.

Referring to FIG. 1, it is assumed that the communication system includes a first BS 105 (BS 1) covering a first service area 100 and a second BS 115 (BS 2) covering a second service area 120. An MS 125 is assumed to be located at a cell edge of the first service area 100.

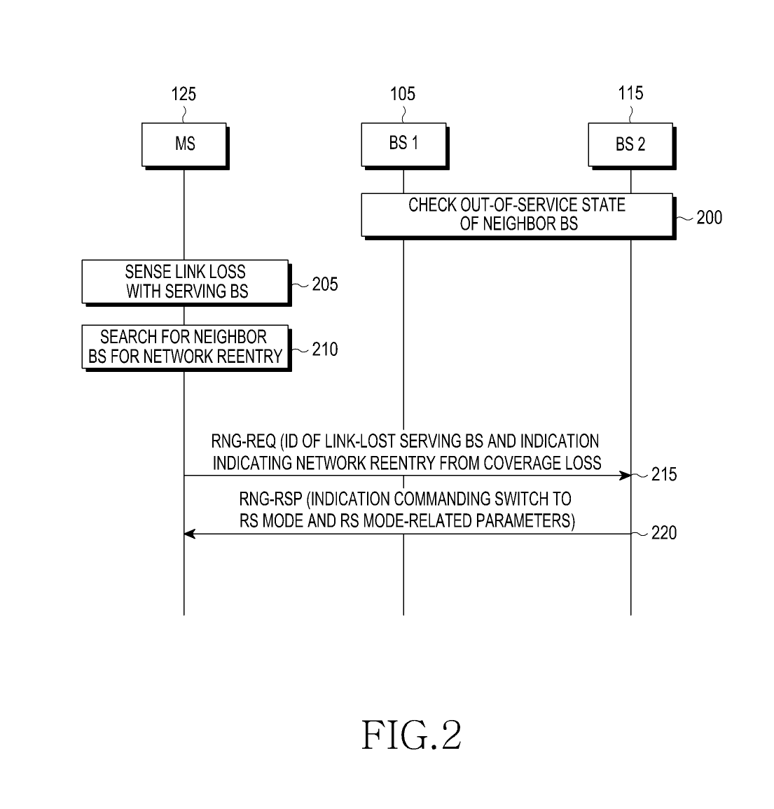

In accordance with an exemplary embodiment of the present invention, a procedure for controlling an RS-mode operation of an MS by a BS involves three primary operations, which will be described with reference to FIG. 2.

FIG. 2 is a diagram illustrating an overall procedure for determining whether an MS is to operate in an RS mode by a BS according to the exemplary embodiment of the present invention.

### (1) The BS Determines Whether a Neighbor BS is in an ‘Out-of-Service State’

The out-of-service state refers to a state in which the neighbor BS cannot operate as a BS for a reason such as breakdown and thus cannot provide any further services to any MSs within its service area.

Referring to FIG. 2, each of BS 1 105 and BS 2 115 periodically monitors whether neighbor BSs included in a neighbor BS list managed by the BS are in the out-of-service state in step 200. In order to monitor whether a neighbor BS included in a neighbor BS list managed by BS 1 105, for example, BS 2 115 is placed in the out-of-service state, BS 1 105 transmits an out-of-service check request message to BS 2 115. While BS 2 115 is taken as an example of a neighbor BS managed by BS 1 105, if BS 1 105 manages a plurality of neighbor BSs, BS 1 105 transmits the out-of-service check request message to the plurality of neighbor BSs.

Upon receipt of a response message including information indicating whether the neighbor BS, that is, BS 2 115 is in the out-of-service state from the neighbor BS, that is, BS 2 115, BS 1 105 is aware whether the neighbor BS, that is, BS 2 115 is in the out-of-service state according to the information. In another exemplary method, BS 1 105 may request results of out-of-service checks on neighbor BSs from an Access Service Network Gateway (ASN GW) and receive the check results from the ASN GW. How the out-of-service state of neighbor BSs is periodically monitored is not closely related to the present invention and thus will not be described in detail herein.

(2) Upon Sensing Link Loss with a Serving BS, an MS Searches for a Neighbor BS to Which it Will Perform Network Reentry.

Upon sensing link loss with its serving BS, BS 1 105 in step 205, the MS 125 searches for a neighbor BS to which the MS 125 will perform network reentry in step 210. The MS may sense link loss under many conditions. For example, if a User Equipment (UE) cannot read SuperFrame Headers (SFHs) received from an enhanced Node B (eNB) successively in an Institute of Electrical and Electronics Engineering (IEEE) 802.16m system, the UE determines that link loss has occurred.

Referring back to FIG. 1, it is assumed that as the MS 125 moves to the edge of the first service area 100 and thus out of the service area of BS 1 105, the MS 125 senses link loss. It is also assumed that BS 2 115 is detected as a neighbor BS capable of servicing the MS 125 as a result of the search. The MS 125 performs a network reentry from coverage loss procedure with BS 2 115. That is, the MS 125 performs an uncontrolled handover with BS 2 115.

To be more specific, the MS 125 transmits a Ranging Request (RNG-REQ) message to BS 2 115 in step 215. The RNG-REQ message includes a serving BS Identifier (BSID), that is, an ID of BS 1 105 and an indication indicating network re-entry from coverage loss.

### (3) It is Determined Whether the Link-Lost Serving BS is in the Out-of-Service State and an Indication Commanding an RS Mode Operation is Transmitted to the MS According to the Determination Result.

Upon receipt of the RNG-REQ message, BS 2 115 acquires the ID of BS 1 105 and the indication indicating network reentry from coverage loss due to movement out of the service area of BS 1 105 from the RNG-REQ message and thus identifies the link-lost BS. In this case, BS 2 115 determines whether BS 1 105 is in the out-of-service state in step 220. If BS 1 105 is in the out-of-service state, BS 2 115 may transmit an indication commanding switch to an RS mode and RS mode-related parameters to the MS 125, for coverage extension of the second service area 115.

For example, if BS 2 115 transmits the indication commanding switch to the RS mode and the RS mode-related parameters to the MS 125 by a ranging-related operation, BS 2 115 transmits a Ranging Response (RNG-RSP) message including the indication commanding switch to the RS mode and the RS mode-related parameters to the MS 125. The RS mode-related parameters include an RS ID (RSID) and a preamble to be broadcast to other MSs that are connected to the MS 125, in the case where the MS 125 operates as an RS. While two RS mode-related parameters are described herein, they are purely exemplary. Thus it is to be clearly understood that more parameters may be required for the RS mode-operation.

In another example, after the network reentry procedure with the MS 125 in a general manner, BS 2 115 determines whether BS 1 105 is in the out-of-service state. If BS 1 105 is in the out-of-service state, BS 2 115 may transmit the indication commanding switch to the RS mode to the MS 125 by a message other than the RNG-REQ/RSP message. For example, BS 2 115 may transmit the RS mode-related parameters to the MS 125 by a High Reliability-COMMAND (HR-CMD) message.

On the contrary, if BS 1 105 is not in the out-of-service state, BS 2 115 determines that the MS 125 performs an uncontrolled handover without control of BS 1 105 and then performs a general handover procedure with the MS 125.

While it may be determined periodically whether a neighbor BS is in the out-of-service state in the first operation, the periodic determination may be omitted. That is, if BS 2 115 acquires the BSID of BS 1 105 and the indication indicating network reentry from coverage loss caused by movement out of the service area of BS 1 105 from the RNG-REQ message received from the MS 125, BS 2 115 can determine whether BS 1 105 is in the out-of-service state. Therefore, BS 2 115 can be aware of the out-of-service state of BS 1 105 without a separate procedure for determining whether each of neighbor BSs managed by BS 2 115 is in the out-of-service state.

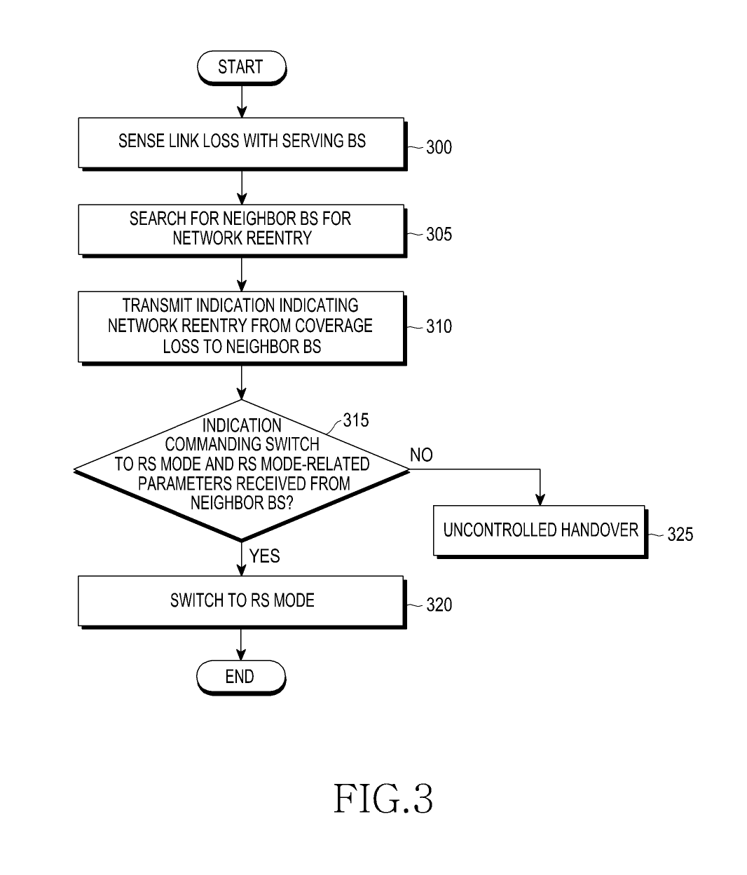

FIG. 3 is a flowchart illustrating an operation of an MS according to an exemplary embodiment of the present invention.

Referring to FIG. 3, the MS senses link loss with the serving BS in step 300 and searches for a neighbor BS to which the MS will perform network reentry in step 305. Upon receipt of a preamble from a neighbor BS as a result of the search, the MS transmits an indication indicating network reentry from coverage loss caused by movement out of the serving BS to the neighbor BS in step 310.

In step 315, the MS monitors reception of an indication commanding switch to an RS mode and RS mode-related parameters from the neighbor BS. Upon receipt of the indication commanding switch to the RS mode and the RS mode-related parameters from the neighbor BS, the MS goes to step 320. The information transmitted and received in steps 310 and 315 may be included in ranging-related messages or messages like an HR-CMD message after network reentry. The MS switches to the RS mode and operates as an RS in step 320. That is, the MS broadcasts an RSID and a preamble received by the RS mode-related parameters to other MSs connected to the MS.

On the contrary, if the MS has not received the indication commanding switch to the RS mode and the RS mode-related parameters from the neighbor BS, the MS performs an uncontrolled handover with the neighbor BS in step 325.

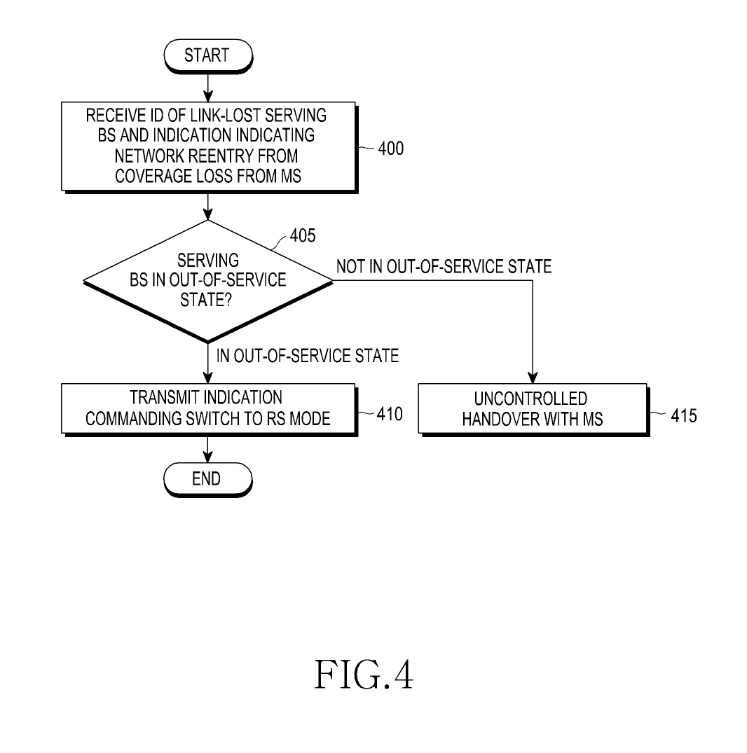

FIG. 4 is a flowchart illustrating an operation of a BS according to an exemplary embodiment of the present invention.

Referring to FIG. 4, the BS receives the ID of a link-lost serving BS and an indication indicating network reentry from coverage loss from an MS in step 400.

In step 405, the BS determines whether the serving BS is in the out-of-service state. If the serving BS is in the out-of-service state, the BS transmits an indication commanding switch to the RS mode to the MS in step 410. On the contrary, if the serving BS is not in the out-of-service state, the BS performs an uncontrolled handover with the MS in step 415. The information transmitted and received in steps 400 and 410 may be included in ranging-related messages or messages like an HR-CMD message after network reentry.

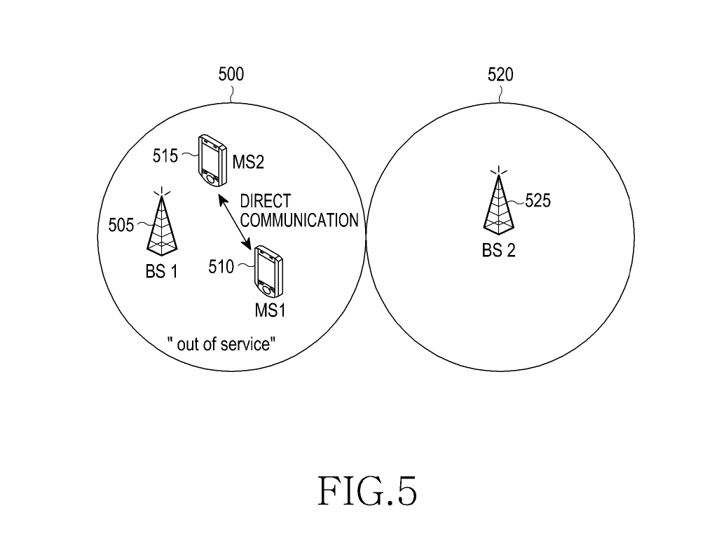

FIG. 5 illustrates an exemplary situation referred to for describing another exemplary embodiment of the present invention.

Referring to FIG. 5, it is assumed that the communication system includes a first BS 505 (BS 1) covering a first service area 500 and a second BS 525 (BS 2) covering a second service area 520. A first MS 510 (MS 1) is assumed to be located at a cell edge of the first service area 500. And upon receipt of a preamble from another MS, a second MS 515 (MS 2), attempting direct communication The first MS 510 is in direct communication with the MS 2.

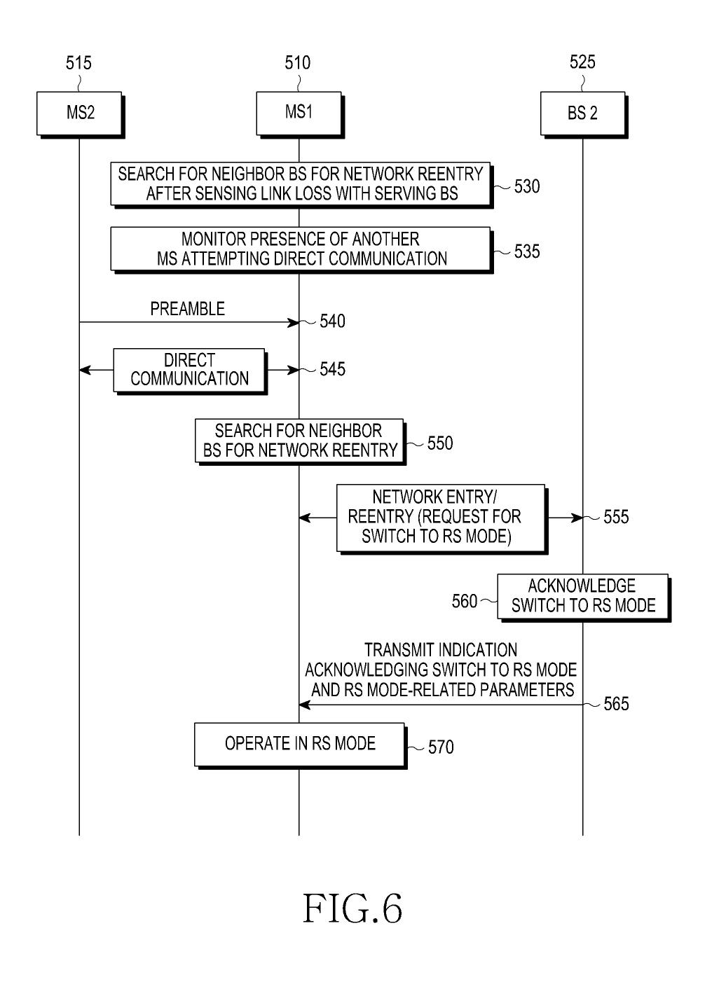

In accordance with another exemplary embodiment of the present invention, a procedure for autonomously controlling its RS mode by an MS includes three primary operations, which will be described with reference to FIG. 6.

FIG. 6 is a diagram illustrating an overall procedure for autonomously determining whether to operate in an RS mode by an MS according to another exemplary embodiment of the present invention.

(1) After Sensing Link Loss with a Serving BS, the MS Searches for a Neighbor BS, for Network Reentry.

Referring to FIG. 6, upon sensing link loss with BS 1, MS 1 510 searches for a neighbor BS, for network reentry in step 530. The process of sensing link loss at MS 1 510 has been described in the first exemplary embodiment of the present invention and thus will not described herein redundantly.

(2) When the MS Fails to Detect a Neighbor BS for Network Reentry, the MS Determines Whether any other MS Attempts Direct Communication to the MS.

If MS 1 510 fails to detect a neighbor BS for network reentry after performing step 530 for a predetermined time, MS 1 510 monitors the presence of another MS attempting direct communication to MS 1 510 in step 535. MS 1 510 senses the presence or absence of a neighbor BS for network reentry by receiving a preamble from the neighbor BS. Likewise, an MS attempting direct communication also broadcasts its preamble. MS 1 510 senses the presence of an MS attempting direct communication by receiving a preamble from the attempting MS.

If MS 1 510 discovers neither a neighbor BS for network reentry nor another MS attempting direct communication, MS 1 510 continues to search for a neighbor BS capable of servicing MS 1 510 or another MS attempting direct communication. Upon receipt of a preamble from another MS attempting direct communication, that is, MS 2 515 later in step 540, MS 1 510 performs a direct communication procedure with MS 2 515 in step 545. In step 550, while MS 1 510 is conducting direct communication with MS 2 515, MS 1 510 periodically monitors the presence of a neighbor BS for network reentry.

If MS 1 510 detects a neighbor BS for network reentry, for example, BS 2 525, MS 1 510 performs network entry/reentry to BS 2 525 in step 555. Herein, MS 1 510 transmits an RNG-REQ message to BS 2 525, while maintaining a direct communication link with MS 2 515. The RNG-REQ message includes information requesting switch to an RS mode. While MS 1 510 transmits the information requesting switch to the RS mode to BS 2 525 by the RNG-REQ message, this is purely exemplary. Instead of the RNG-REQ message, MS 1 510 may transmit the information requesting switch to the RS mode to BS 2 525 by a High Reliability-REQuest (HR-REQ) message.

(3) The MS that has Transmitted the Information Requesting Switch to the RS Mode is Allowed to Operate in the RS Mode.

When acquiring the information requesting switch to the RS mode from the RNG-REQ message received from MS 1 510, BS 2 525 allows MS 1 510 to operate in the RS mode in step 560. That is, BS 2 525 transmits an indication acknowledging switch to the RS mode and RS mode-related parameters to MS 1 510 in step 565. The RS mode-related parameters include, for example, an RSID and a preamble for the RS mode.

Upon receipt of the indication acknowledging switch to the RS mode and the RS mode-related parameters, MS 1 510 operates in the RS mode in step 570.

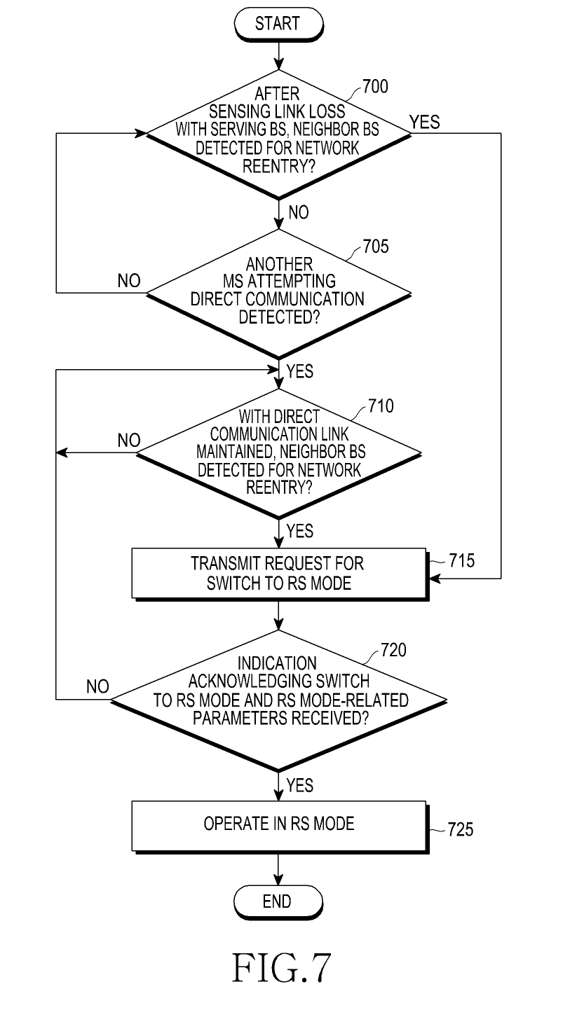

FIG. 7 is a flowchart illustrating an operation of an MS according to another exemplary embodiment of the present invention.

Referring to FIG. 7, upon sensing link loss with a serving BS, the MS searches for a neighbor BS, for network reentry in step 700. If the MS fails to detect a neighbor network for network reentry, the MS proceeds to step 705. On the other hand, if the MS detects a neighbor network for network reentry, the MS proceeds to step 715.

In step 705, the MS monitors the presence of another MS attempting direct communication to the MS. Upon receipt of a preamble from another MS attempting direct communication, the MS goes to step 710. On the contrary, if the MS fails to receive a preamble from another MS attempting direct communication, the MS repeats step 700 for a predetermined time.

In step 710, the MS performs a direct communication procedure with the attempting MS and while the MS is conducting direct communication with the attempting MS, the MS periodically monitors the presence of a neighbor BS for network reentry. If the MS has not discovered a neighbor BS for network reentry, the MS repeats step 710 for a predetermined time. Upon detection of a neighbor BS for network reentry, the MS transmits a message requesting switch to an RS mode to the neighbor BS in step 715 and goes to step 720. The message requesting switch to the RS mode to the neighbor BS may be a ranging-related message or any other message.

In step 720, the MS monitors reception of an indication acknowledging switch to the RS mode and RS mode-related parameters from the neighbor BS. Upon receipt of the indication acknowledging switch to the RS mode and the RS mode-related parameters, the MS proceeds to step 725. The RS mode-related parameters include, for example, an RSID and a preamble for the RS mode. The MS operates in the RS mode and transmits the RSID and the preamble for the RS mode to other MSs connected to the MS in step 725.

On the other hand, if the MS fails to receive the indication acknowledging switch to the RS mode and the RS mode-related parameters in step 720, the MS repeats step 710 for a predetermined time.

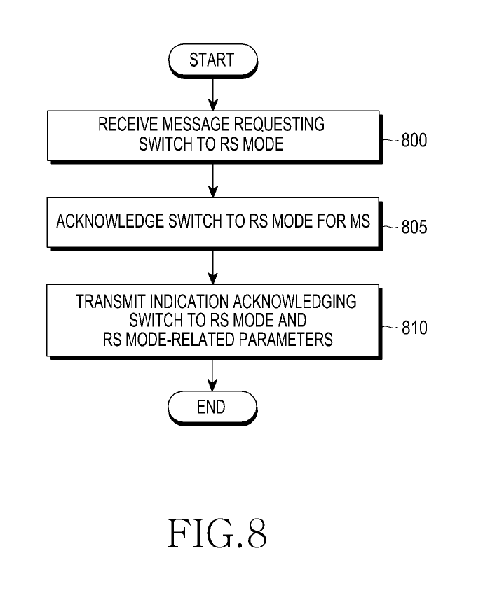

FIG. 8 is a flowchart illustrating an operation of a BS according to another exemplary embodiment of the present invention.

Referring to FIG. 8, the BS receives a message requesting switch to an RS mode from an MS in step 800 and proceeds to step 805. The message requesting switch to the RS mode may be an RNG-REQ message or any other message.

The BS determines to acknowledge the MS's switching to the RS mode in step 805 and transmits an indication acknowledging switch to RS mode and RS mode-related parameters to the MS in step 810. The RS mode-related parameters include, for example, an RSID and a preamble for the RS mode.

FIG. 9 is a block diagram of a BS that operates according to an exemplary embodiment of the present invention.

Referring to FIG. 9, a BS 900 includes a controller 905, a receiver 910, a decider 915, and a transmitter 920. For the sake of convenience, it is assumed that the BS 900 can operate according to the first or second exemplary embodiment of the present invention as described above.

In the case where the BS 900 operates according to the first exemplary embodiment of the present invention, the receiver 910 receives an ID of a link-lost serving BS and an indication indicating network reentry from coverage loss from an MS.

Then, the controller 905 determines whether the serving BS is in an out-of-service state. If the serving BS is in the out-of-service state, the controller 905 controls the decider 915 to allow the MS to operate in the RS mode and controls the transmitter 905 to transmit an indication acknowledging switch to an RS mode and RS mode-related parameters to the MS. The RS mode-related parameters include, for example, an RSID and a preamble for the RS mode. On the contrary, if the serving BS is not in the out-of-service state, the controller 905 controls the decider 915 to determine to perform an uncontrolled handover with the MS and to generate a message to be transmitted for the uncontrolled handover procedure.

The transmitter 920 transmits the indication acknowledging switch to the RS mode and the RS mode-related parameters received from the decider 915 to the MS under the control of the controller 905. The transmitter 920 may transmit the indication acknowledging switch to the RS mode and the RS mode-related parameters by a message for the uncontrolled handover procedure, a ranging-related message, or a message transmitted after network reentry, like an HR-CMD message.

In the case where the BS 900 operates according to the second exemplary embodiment of the present invention, the receiver 910 receives a message requesting switch to an RS mode from an MS. The message requesting switch to the RS mode may be a ranging-related message or any other message.

Then the controller 905 controls the decider 915 to determine to acknowledge switch to the RS mode for the MS.

The decider 915 provides an indication acknowledging switch to an RS mode and RS mode-related parameters to the transmitter 920 under the control of the controller 905. The RS mode-related parameters include, for example, an RSID and a preamble for the RS mode.

The transmitter 920 transmits the indication acknowledging switch to the RS mode and the RS mode-related parameters to the MS under the control of the controller 905.

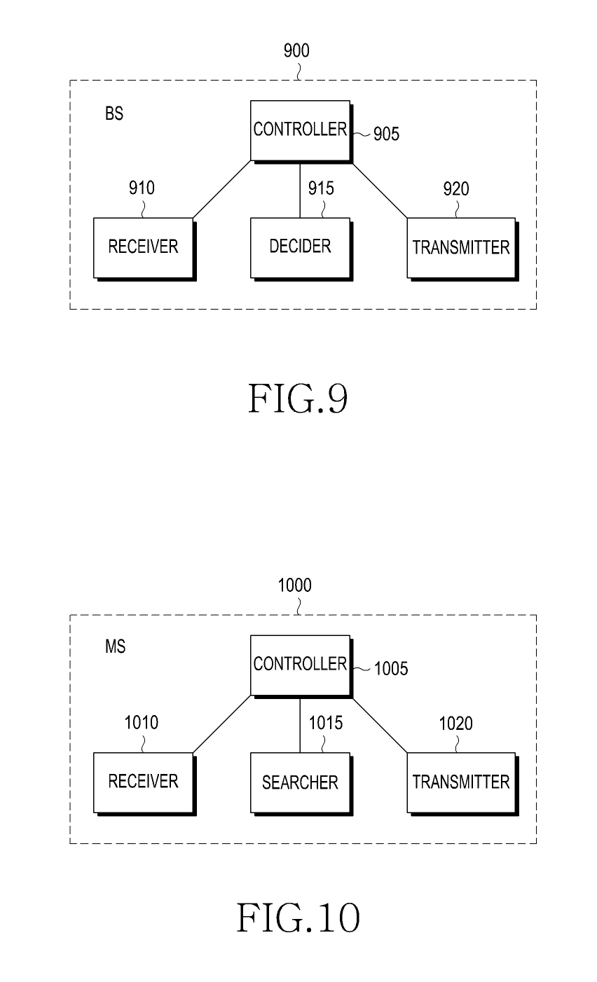

FIG. 10 is a block diagram of an MS that operates according to an exemplary embodiment of the present invention.

Referring to FIG. 10, an MS 1000 includes a controller 1005, a receiver 1010, a searcher 1015, and a transmitter 1020. For the convenience' sake of description, it is assumed that the MS 1000 can operate according to the first or second exemplary embodiment of the present invention.

In the case where the MS 1000 operates according to the first exemplary embodiment of the present invention, the controller 1005 senses link loss with a serving BS and controls the searcher 1015 to search for a neighbor BS for network reentry. If the searcher 1015 receives a preamble from a neighbor BS as a result of the search, the controller 1005 controls the transmitter 1020 to transmit an indication indicating network reentry from coverage loss to the neighbor BS.

Later, the receiver 1010 receives an indication acknowledging switch to an RS mode and RS mode-related parameters from the neighbor BS. For example, the RS mode-related parameters include an RSID and a preamble for the RS mode. The controller 1005 controls the MS 1000 to operate in the RS mode, that is, as an RS. In addition, the controller 1005 controls the transmitter 1020 to broadcast the RSID and the preamble received in the RS mode-related parameters to other MSs connected to the MS 1000.

In the case where the MS 1000 operates according to the second exemplary embodiment of the present invention, upon sensing link loss with the serving BS, the controller 1005 controls the searcher 1015 to search for a neighbor BS for network reentry. If no neighbor BS is detected, the controller 1005 controls the searcher 1015 to search for another MS attempting direct communication to the MS 1000. Upon receipt of a preamble from another MS attempting direct communication, the controller 1005 conducts direct communication with the detected MS and controls the searcher 1015 to search for a BS for network reentry, while maintaining the direct communication link. In the absence of a neighbor BS for network reentry, the controller 1005 controls the searcher 1015 to search for a neighbor BS for network reentry for a predetermined time. Upon receipt of a preamble from another MS attempting direct communication as a result of the search, the controller 1005 controls the searcher 1015 to search for a neighbor BS for network reentry for a predetermined time.

Meanwhile, in the presence of a neighbor BS for network reentry, the controller 1005 controls the transmitter 1020 to transmit a message requesting switch to the RS mode to the neighbor BS. The message requesting switch to the RS mode may be a ranging-related message or any other message.

The receiver 1010 receives an indication acknowledging switch to an RS mode and RS mode-related parameters from the neighbor BS. The RS mode-related parameters include, for example, an RSID and a preamble for the RS mode. Then the controller 1005 controls the MS 1000 to operate in the RS mode and controls the transmitter 1020 to transmit the RSID and the preamble for the RS mode to other MSs connected to the MS 1000. If the receiver 1010 has not received the indication acknowledging switch to the RS mode from the neighbor BS, the controller 1005 controls the searcher 1015 to search for a neighbor BS for network reentry for a predetermined time.

As is apparent from the above description, exemplary embodiments of the present invention propose conditions for controlling an MS's switching to an RS mode. Thus, upon sensing link loss with a serving BS, the MS requests switching to the RS mode to a neighbor BS for network reentry. If the serving BS is in an out-of-service state due to breakdown and thus can service none of MSs within its service area, the MS receives a response to the request from the neighbor BS and operates in the RS mode. An MS communicating directly with another MS transmits a request for switching to an RS mode to a neighbor BS for network reentry. In this manner, the RS mode of MSs is controlled, the coverage of the neighbor BS is extended, and unnecessary RS-mode operations are reduced.

While the invention has been shown and described with reference to certain exemplary embodiments thereof, it will be understood by those of ordinary skill in the art that various changes in form and details may be made therein without departing from the spirit and scope of the present invention as defined by the following claims and their equivalents.

What is claimed is:

1. A method for a Mobile Station (MS) to control a Relay Station (RS) mode of the MS in a communication system, the method comprising:
sensing a link loss with a serving Base Station (BS);
searching for a neighbor BS for network reentry;
transmitting to the neighbor BS an Identifier (ID) of the serving BS and an indication indicating network reentry from coverage loss caused by movement out of a service area of the serving BS; and
operating in the RS mode, upon receipt of an indication commanding switch to the RS mode from the neighbor BS,
wherein the RS mode is a mode in which the MS operates as an RS.

2. The method of claim 1, further comprising:
searching for another MS attempting direct communication to the MS, if a neighbor BS for network reentry is not detected after the link loss with the serving BS is sensed;
establishing, in the presence of another MS attempting direct communication to the MS, a direct communication link with the attempting MS and searching for a neighbor BS for network reentry, while the direct communication link is maintained; and
transmitting a message requesting switch to the RS mode to the neighbor BS.

3. The method of claim 1, further comprising:
receiving RS mode-related parameters from the neighbor BS; and
broadcasting the RS mode-related parameters to other MSs connected to the MS, when the MS operates in the RS mode,
wherein the RS mode-related parameters include an RS ID of the MS and a preamble.

4. The method of claim 1, further comprising performing an uncontrolled handover procedure with the neighbor BS, if the indication commanding switch to the RS mode is not received from the neighbor BS.

5. A method for a Base Station (BS) to control a Relay Station (RS) mode of a Mobile Station (MS) in a communication system, the method comprising:
receiving from the MS an Identifier (ID) of a link-lost serving BS and an indication indicating network reentry from coverage loss caused by movement out of a service area of the serving BS;
determining whether the serving BS cannot service any MS within the service area of the serving BS in an out-of-service state; and
transmitting an indication commanding switch to the RS mode to the MS, if the BS is in the out-of-service state,
wherein the RS mode is a mode in which the MS operates as an RS.

6. The method of claim 5, further comprising performing an uncontrolled handover procedure with the MS, if the serving BS is not in the out-of-service state.

7. The method of claim 5, further comprising:
determining to acknowledge switch to the RS mode for the MS, upon receipt of a message requesting switch to the RS mode from the MS; and
transmitting an indication acknowledging switch to the RS mode and RS mode-related parameters to the MS.

8. The method of claim 7, wherein the RS mode-related parameters include an RS ID of the MS and a preamble to be broadcast to other MSs connected to the MS by the MS, when the MS operates in the RS mode.

9. A Mobile Station (MS) for controlling a Relay Station (RS) mode in a communication system, the MS comprising:
a controller for sensing a link loss with a serving Base Station (BS), searching for a neighbor BS for network reentry, and operating in the RS mode, upon receipt of an indication commanding switch to the RS mode from the neighbor BS; and
a transmitter for transmitting to the neighbor BS an Identifier (ID) of the serving BS and an indication indicating network reentry from coverage loss caused by movement out of a service area of the serving BS,
wherein the RS mode is a mode in which the MS operates as an RS.

10. The MS of claim 9, wherein if a neighbor BS for network reentry is not detected after the link loss with the serving BS is sensed, the controller searches for another MS attempting direct communication to the MS, if the other MS attempting direct communication to the MS is found, establishes a direct communication link with the attempting MS, and searches for the neighbor BS for network reentry, while the direct communication link is maintained, and if a neighbor BS for network reentry is detected, the transmitter transmits a message requesting switch to the RS mode to the neighbor BS under the control of the controller.

11. The MS of claim 10, wherein if the receiver receives RS mode-related parameters from the neighbor BS, the controller controls the transmitter to broadcast the RS mode-related parameters to other MSs connected to the MS, when the controller operates in the RS mode.

12. The MS of claim 9, wherein if the indication commanding switch to the RS mode is not received from the neighbor BS, the controller performs an uncontrolled handover procedure with the neighbor BS.

13. A Base Station (BS) for controlling a Relay Station (RS) mode of a Mobile Station (MS) in a communication system, the BS comprising:
a receiver for receiving from the MS an Identifier (ID) of a link-lost serving BS and an indication indicating network reentry from coverage loss caused by movement out of a service area of the serving BS;
a controller for determining whether the serving BS cannot service any MS within the service area of the serving BS in an out-of-service state; and
a transmitter for transmitting an indication commanding switch to the RS mode to the MS, if the BS is in the out-of-service state,
wherein the RS mode is a mode in which the MS operates as an RS.

14. The BS of claim 13, wherein if the serving BS is not in the out-of-service state, the controller performs an uncontrolled handover procedure with the MS.

15. The BS of claim 13, wherein if the receiver receives a message requesting switch to the RS mode from the MS, the controller determines to acknowledge switch to the RS mode for the MS and controls the transmitter to transmit an indication acknowledging switch to the RS mode and RS mode-related parameters to the MS.

16. The BS of claim 15, wherein the RS mode-related parameters include an RS ID of the MS and a preamble to be broadcast to other MSs connected to the MS by the MS, when the MS operates in the RS mode.
